(19) United States
(12) Patent Application Publication
(10) Pub. No.: US 2005/0162653 A1
(43) Pub. Date: Jul. 28, 2005

(54) Apparatus for measuring spectral absorbance using a unique optical modulator to produce spectral absorbance data and process for making same

(76) Inventors: David Reginald Carver, Colorado Springs, CO (US); Daniel Patrick Brennan, Colorado Springs, CO (US)

Correspondence Address: David R. Carver, 4365 Reginald Ct., Colorado Springs, CO, 80906, US

(21) Appl. No.: 10/764,548

(22) Filed: Jan. 27, 2004

(51) Int. Cl. G01N 21/59

(52) U.S. Cl. 356/432

(57) ABSTRACT

An apparatus for measuring spectral absorbance using unique optical modulator capable of temporally changing the spectral wavelength proportion of the light source to produce spectral absorbance data of a sample having: a) a light source able to produce light in the desired wavelength region to be measured for spectral absorbance. b) optical modulator capable of temporally changing the spectral wavelength proportion of the light source. c) sample holder capable of introducing the sample into the light path and d) photosensor for determining the total light intensity after passing through the sample.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of spectral absorbance measurement and more specifically to a machine for measuring spectral absorbance using unique optical modulator to produce spectral absorbance data and process for making same.

Spectral absorbance of flowing liquids is difficult to detect and measure. Measurement of spectral absorbance is particularly useful in high performance liquid chromatography (HPLC). However, many instruments that are able to rapidly obtain spectral absorbance data in flowing liquids are complex and expensive. Their limitations are due to the optical arrangement and associated sensor elements that have multiple sensors which are expensive both in terms of production and utilization. However, they are able to obtain complete spectral absorbance data in a single operation. This allows the researcher to obtain additional information about the eluting compounds in a real time environment.

Obtaining such data without involving additional labor of isolation and subsequent manipulation of the sample into another instrument gives the analytical technique ability to monitor the separation efficiency of the chromatography process and also determine variations in the spectral absorbance of the compound(s) of interest. (Principles of Instrumental Analysis, Third Edition. Skoog, Douglas A., 1985, p. 294). Instruments which measure complete spectral absorbance are typically comprised of a broad spectrum light source, a sample cell for the flowing liquid, a dispersive element, and a multiple element sensor array. The wavelength regions of typical interest for most applications are in the near UV region. This region is where many compounds of interest show absorbance of UV light, yet the light is of long enough wavelength such that the atmosphere of the earth does not absorb the light. Visible light spectra are also of interest. These wavelengths regions are from 180 nm-1050 nm.

The data from the multi element sensor array is sent into an electronic conditioning device to perform the analog to digital conversion and do calculations to determine absorbance. (J. M. Gill, Chromatography, Series 1, vol. 1, p. 188, International Scientific Communication, Inc). Variations in the lamp intensity are compensated by a variety of different methods. (U.S. Pat. No. 5,699,156). This method has met with a certain degree of success and applicability.

Such systems are costly in terms of implementation. There is a need for a more simple method of obtaining the same data in an easier to implement method. The present invention is directed to meeting these needs.

### BRIEF SUMMARY OF THE INVENTION

It is an object of the present invention to provide a new and useful apparatus for measuring spectral absorbance.

It is another object to provide an inexpensive apparatus particularly adapted to measure spectral absorbance of flowing liquids.

In accordance with a preferred embodiment of the present invention, there is disclosed an apparatus for measuring the spectral absorbance of a sample using a unique optical modulator to produce spectral absorbance data. The method is comprised of the following elements:
a) an optical light source able to produce light in the desired wavelength region to be measured for spectral absorbance.
b) optical modulator capable of temporally changing the spectral wavelength proportion of the light source
c) sample holder capable of introducing the sample into the light path
d) photosensor(s) for determining the total light intensity after passing through the sample.

In accordance with a preferred embodiment of the invention, there is disclosed a method according to claim 1, wherein the optical modulator is between the light source and the sample holder. The optical light source is selected to produce light in the wavelength regions in the spectrum that are desired to be measured. The optical modulator is capable of producing temporal variations in the wavelength ratios of the optical light source.

In accordance with a preferred embodiment of the invention, there is disclosed a method according to claim 1, wherein the sample holder is between the light source and the optical modulator. Following the light path from the light source through the various components, the sample holder can be placed either in between the light source and optical modulator or after the optical modulator. The photosensor is the final element in the optical path and enables the conversion of light into an electrical signal. A typical photosensor would be a silicon photodiode (UDT Sensors, Hawthorne, Calif.).

The conversion of the photosensor's electrical output into usable data accessible to the user is performed by known techniques generally using analog to digital conversion and digital processing techniques to present the data to the user.

The method may further include optical elements, which monitor the overall intensity of the light source and compensate the output for variations and it's level independent from the ratio of wavelength intensity modulation.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a method according to claim 2, wherein a lens or focusing mirror is between the light source and the optical modulator.

In accordance with a preferred embodiment of the invention, there is disclosed. a method according to claim 2, wherein a lens or focusing mirror is between the optical modulator and sample photosensor.

In accordance with a preferred embodiment of the invention, there is disclosed. a method according to claim 3, wherein a lens or focusing mirror is between the light source and sample holder.

In accordance with a preferred embodiment of the invention, there is disclosed a method according to claim 3, wherein a lens or focusing mirror is between the sample holder sample photosensor.

In accordance with a preferred embodiment of the invention, there is disclosed a method according to claim 1, wherein the photosensor is a silicon photodiode.

In accordance with a preferred embodiment of the invention, there is disclosed a method according to claim 1, wherein the optical spectral measurement absorbance range is wavelengths between 180 nm and 1050 nm.

In accordance with a preferred embodiment of the invention, there is disclosed a method for detecting and measuring spectral absorbance of a sample comprising: a) a light source able to produce light in the desired wavelength region to be measured for spectral absorbance. b) optical modulator capable of temporally changing the spectral wavelength proportion of the light source. c) sample holder capable of introducing the sample into the light path d) photosensor for determining the total light intensity after passing through the sample. e) a beam splitter for splitting a portion of the light prior to passing through the sample cell to a reference photosensor.

In accordance with a preferred embodiment of the invention, there is disclosed a method according to claim 10, wherein the optical modulator is between the light source and the sample holder.

In accordance with a preferred embodiment of the invention, there is disclosed a method according to claim 10, wherein the sample holder is between the light source and the optical modulator.

In accordance with a preferred embodiment of the invention, there is disclosed a method according to claim 11, wherein a lens or focusing mirror is between the light source and the optical modulator.

In accordance with a preferred embodiment of the invention, there is disclosed a method according to claim 11, wherein a lens or focusing mirror is between the optical modulator and sample photosensor.

In accordance with a preferred embodiment of the invention, there is disclosed a method according to claim 12, wherein a lens or focusing mirror is between the light source and sample holder.

In accordance with a preferred embodiment of the invention, there is disclosed a method according to claim 12, wherein a lens or focusing mirror is between the sample holder sample photosensor.

In accordance with a preferred embodiment of the invention, there is disclosed a method according to claim 10, wherein the photosensor is a silicon photodiode.

In accordance with a preferred embodiment of the invention, there is disclosed a method according to claim 10, wherein the optical spectral measurement absorbance range are wavelengths between 180 nm and 1050 nm.

In accordance with a preferred embodiment of the invention, there is disclosed an apparatus for determination of spectral absorbance comprising: a) optical light source emitting in the desired spectral absorbance region b) an optical modulator comprised of a circular or spherical optically transmissive element mounted such that a rotation of the element induces a change in the wavelength proportions of the transmitted light in the measurement spectrum area. c) sample holder capable of introducing the sample into the light path d) photosensor for determining the total light intensity after passing through the sample.

In accordance with a preferred embodiment of the invention, there is disclosed. an apparatus for determination of spectral absorbance comprising: a) optical light source emitting in the desired spectral absorbance region b) an optical modulator comprised of a circular or spherical optically transmissive element mounted such that a rotation of the element induces a change in the wavelength proportions of the transmitted light in the measurement spectrum area c) sample holder capable of introducing the sample into the light path d) photosensor for determining the total light intensity after passing through the sample. e) a beam splitter for splitting a portion of the light prior to passing through the sample cell to a reference photosensor.

In accordance with a preferred embodiment of the invention, there is disclosed a method where claims 1-20 use an analog to digital converter to obtain the output of the photosensor(s).

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an isometric view of the components comprising an embodiment of the present invention.

FIG. 2 is an isometric view of an alternative optical arrangement, no lens are used.

FIG. 3 is an isometric view of an alternative optical arrangement; the optical modulator is a sphere mounted in line with the optical path.

FIG. 4 is an isometric view of an alternative optical arrangement; the sample holder is located before the optical modulator.

FIG. 5 is an isometric view of the optical modulator.

FIG. 6 is an isometric view of an alternative optical modulator, single optical disk with varying absorbance and or interference coating(s).

FIG. 7 is an isometric view of an alternative optical modulator; multiple optical materials are used.

FIG. 8 is an isometric view of an alternative optical modulator, multiple optical materials in the form of a sphere.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The present invention is directed to a method for determining spectral absorbance and to an apparatus useful with the method of the present invention. The method and apparatus of the present invention are particularly adapted for determining spectral absorbance in flowing liquids. The apparatus described has particular application in the field of chromatography and capillary electrophoresis. As described above, the existing instrumentation for performing fast spectral determinations is expensive and relative to this method complicated.

Accordingly, the present invention provides a unique method for measuring spectral absorbance, which involves making multiple determinations of light intensities at different positions of the optical modulator.

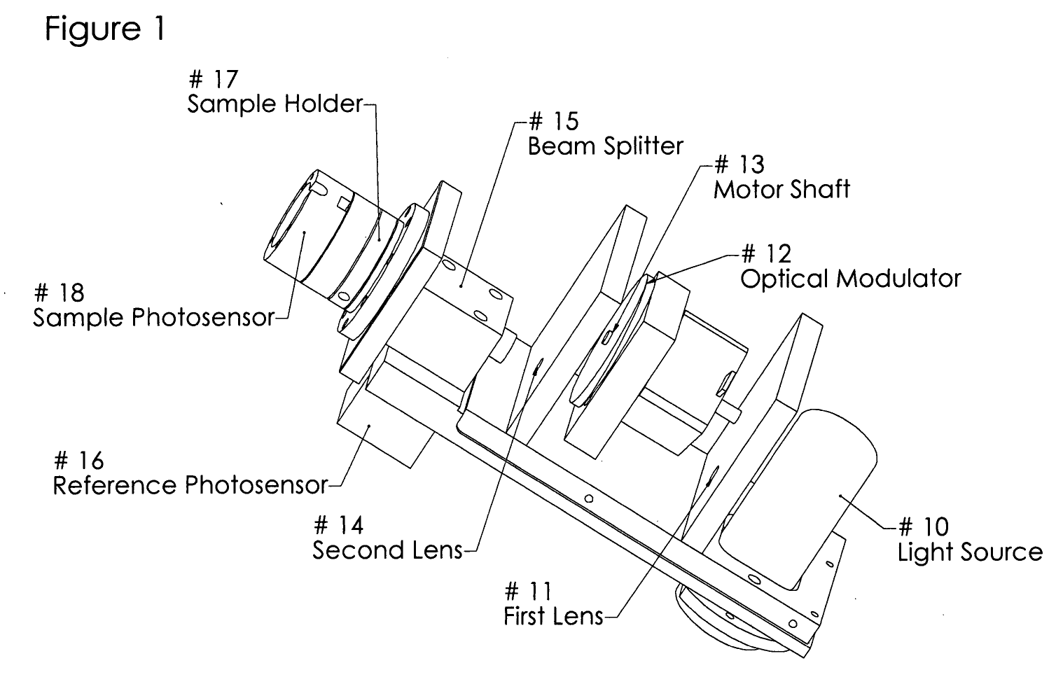

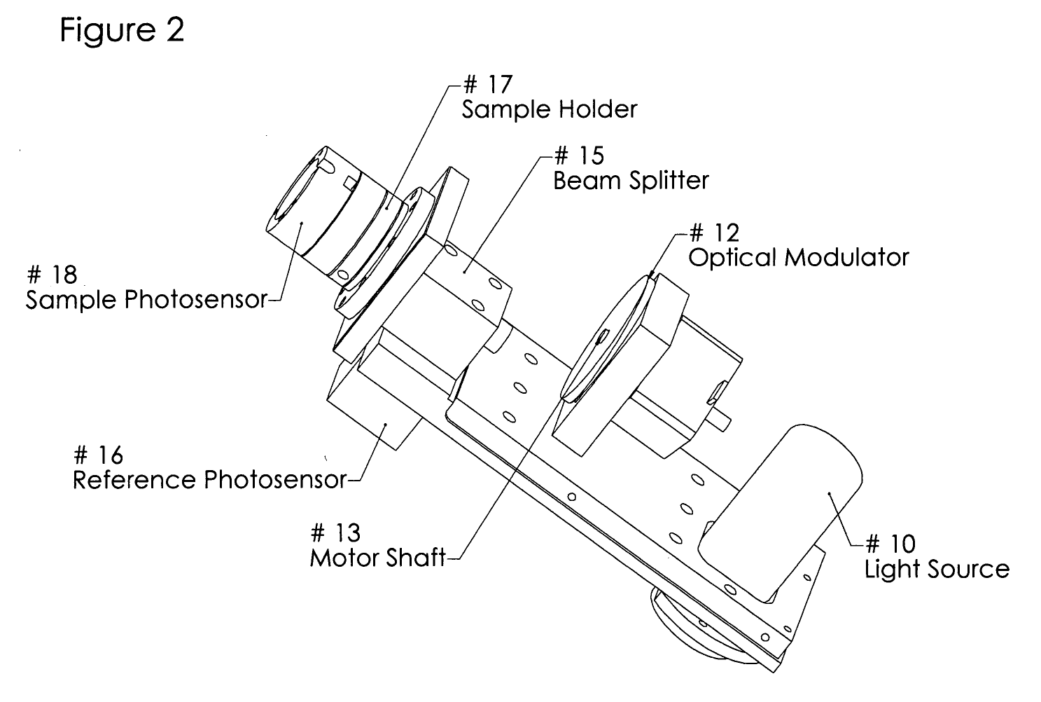

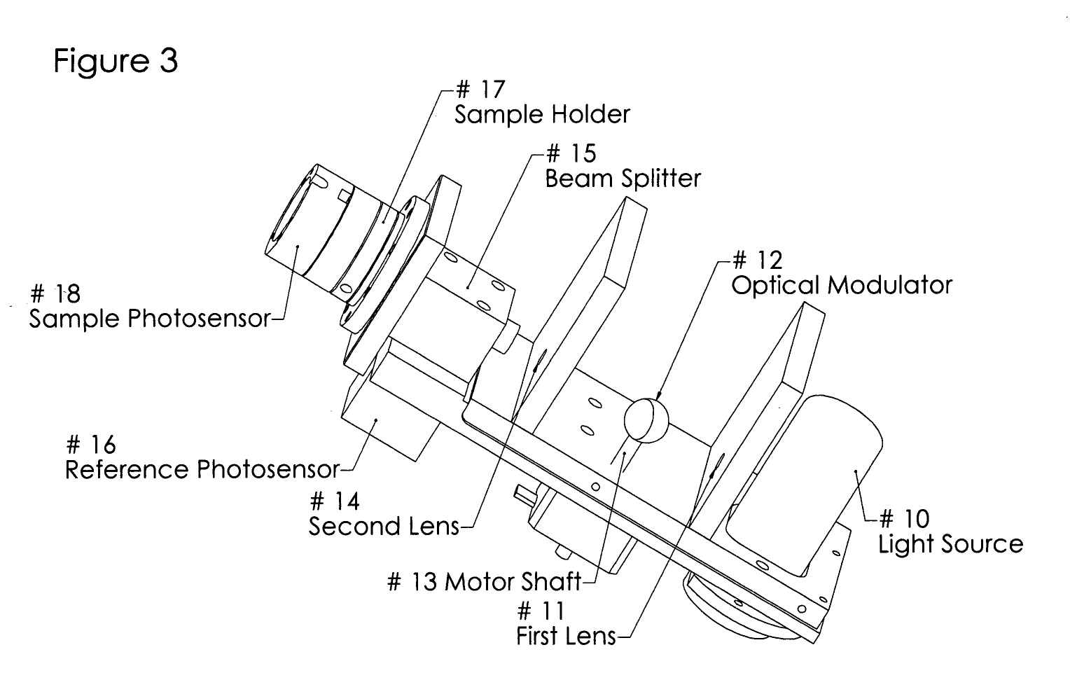

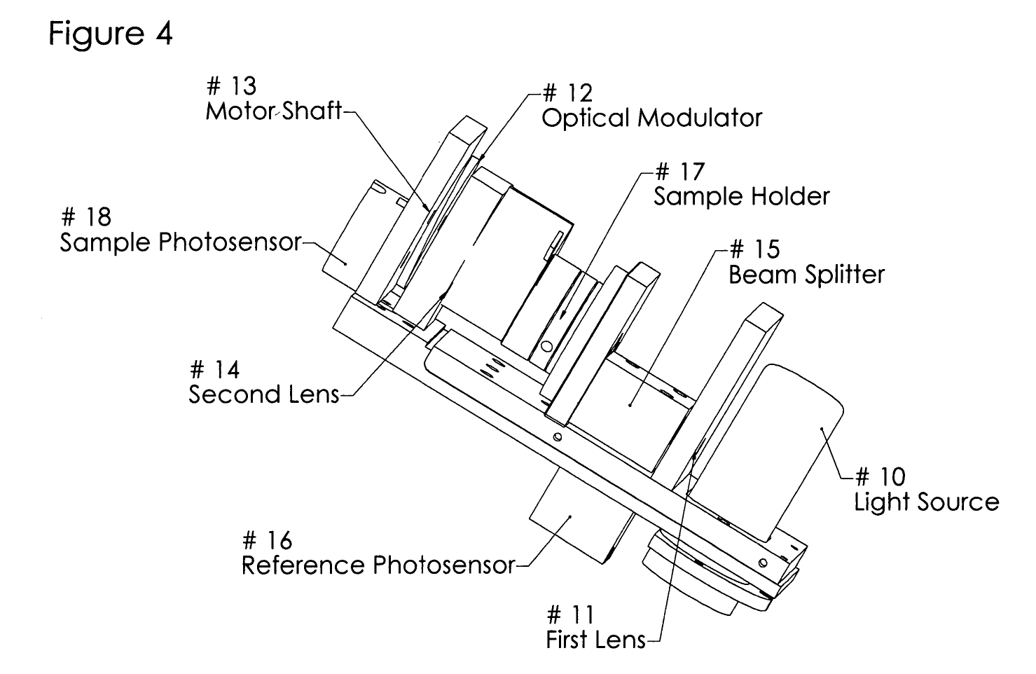

In the example shown in FIG. 1, (also reference alternate FIGS. 2, 3, and 4) the light source (10) outputs intensities of light at various wavelengths. Lens (11) can optionally be included to help collect and focus the light through optical modulator (12). Alternatively, a lens or lenses may be substituted with optical mirrors, which perform the same function as the lenses. Optical modulator (12) can be comprised of a circular disc of material that has the ability to differentially transmit various spectral wavelengths at a given radius from its center as the element is rotated about it's center. This element can be mounted on the shaft of the motor (13) or other device to produce rotational selection. A second lens (14) can be mounted after the optical modulator to help focus the light onto a beam splitting devise (15) such beam splitting devises are known and (ref. 4). This beam splitting device is present to monitor the overall intensity of all the wavelengths combined to compensate for variations in light intensity from the light source. A portion of its light from the beam splitter is sent to a reference photosensor (16). The output of this is used as a normalization constant for the light that has passed through the sample. This compensates for variations of the intensity of the light source. The remainder of the light that did not go to the photosensor (16) is sent to sample holder (17). What light is not absorbed in sample holder (17) impinges on photosensor (18), such as a silicon photodiode with response from 180 nm to 1050 nm.

Shown in FIG. 5, is a more detailed diagram of one form of the optical modulator. In this diagram we see the circular optical modulator composed of 2 pieces of glass bonded together to make a balanced flat disc element. Alternatively the wedges of glass may be bonded together to make a spherical optical element. The two pieces of glass are manufactured as wedges such that when bonded together they form a single circular disc or sphere. This optical modulator is oriented such that the light is passed through perpendicular to the radius of the disc. Typically depending upon the diameter of the light beam from the light source the distance from the center of the disc would be chosen to be sufficient such that the light did not pass through the center of the disc and with adequate radius for all light to pass through the disc and not beyond the circumference of the disc.

Let us define the orientation of this wedged glass in a radially symmetric manner about the center. If, by way of example, glass number 21 is comprised of Hoya-#UV-22 and the other wedge, and glass number 22 is comprised of Hoya-#B380, then we will define orientation 1 of n orientations to be the position where glass #1 is the thickest. As the optical modulator is rotated about its center perpendicular to the disc of the glass, the thickness of glass #21 and glass #22 change. If the rotation of the optical modulator is divided into n/2 number of rotational segments, the spectral light intensity, being the ratio of intensity of wavelength A to the intensity of wavelength B, will be different in each of the n rotational orientations.

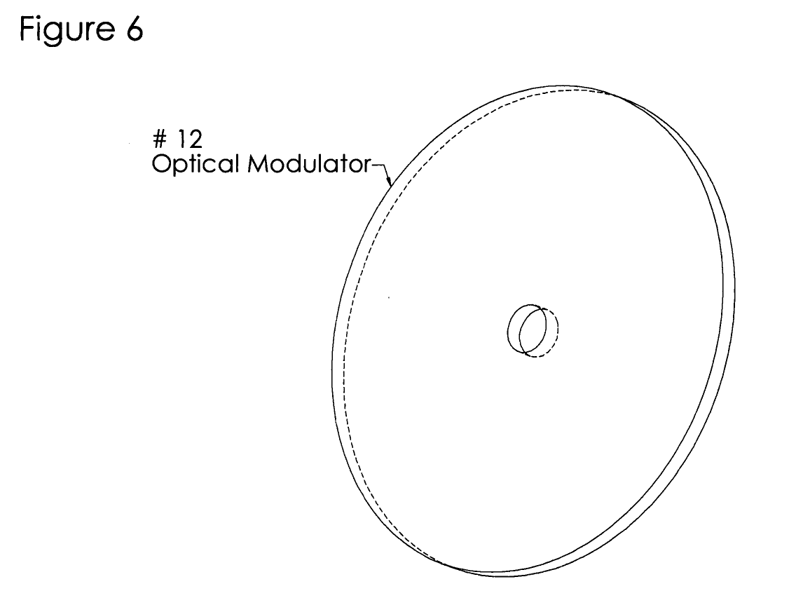

FIG. 6, shows another form of the optical modulator. In this case the optical modulator is a flat optical disk, such as fused silica, with a varying coating resulting in the same modulation as described above.

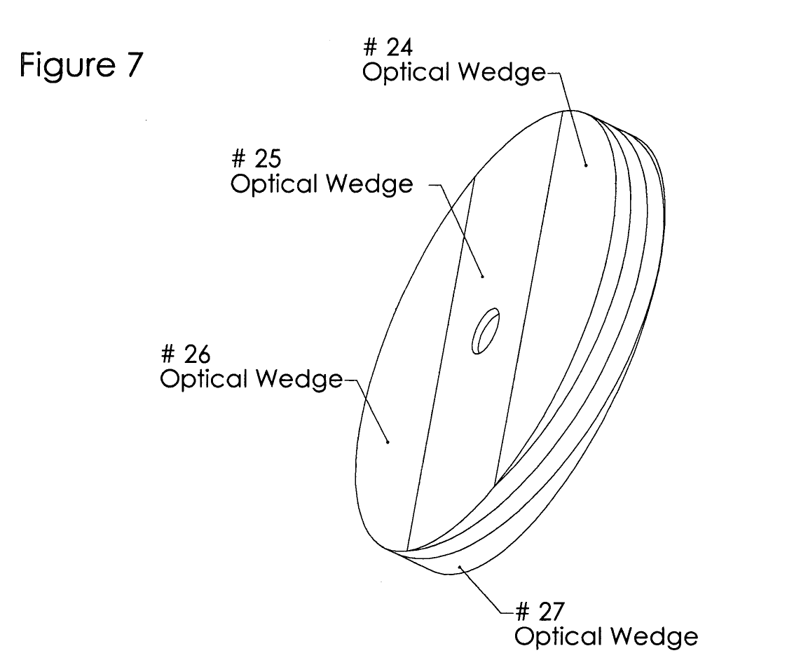

FIG. 7, illustrates another possible form of the optical modulator. In this case three different optical wedges number 24, 25 and 26, are used to produce the desired modulation, and optical wedge 27 is used to balance the assembly.

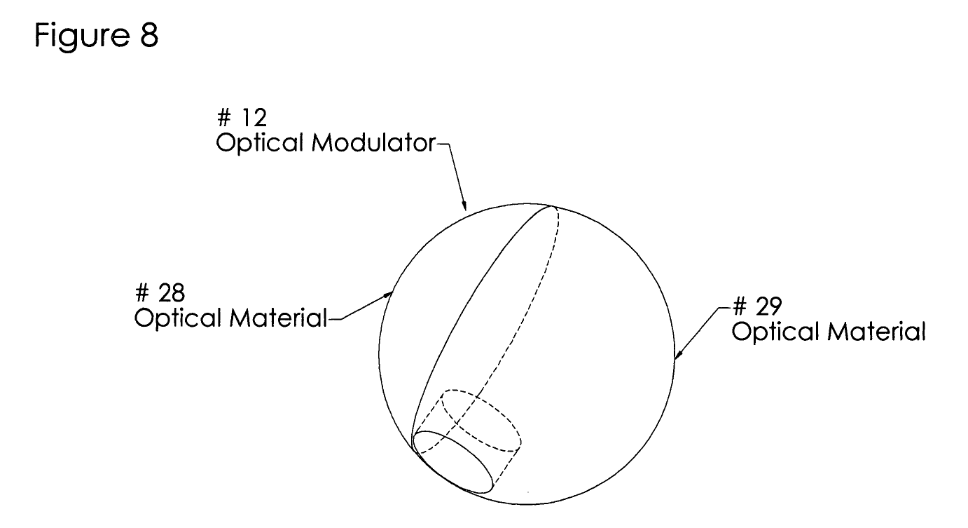

FIG. 8, illustrates one possible alternate form of the optical modulator. In this case the optical modulator is a sphere composed of two different optical materials numbers 28 and 29, resulting in modulation described above. The sphere also has the added advantage of being mounted in line with the optical path.

In order to make a complete spectral absorbance measurement, the light intensities from the photosensors in FIG. 1 (16 and 18) are determined using analog to digital conversion devices such as the LT2400 (Linear Technologies, Milpitas, Calif.). Beginning with a known orientation such as where glass #21 is thickest a set of A/D conversions of the photosensors is performed. The optical modulator is then rotated to its next position, which is a non-zero fractional increment of its complete rotation. Another A/D conversion of the photosensors (15 and 18) is taken. This is repeated until a complete set of n A/D readings have been taken. With this particular optical modulator a rotation thorough 180 degrees divided into n segments would be sufficient to produce n number of wavelength readings in the observed spectral region.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A apparatus for measuring spectral absorbance using unique optical modulator to produce spectral absorbance data comprising:
a) a light source able to produce light in the desired wavelength region to be measured for spectral absorbance.
b) optical modulator capable of temporally changing the spectral wavelength proportion of the light source.
c) sample holder capable of introducing the sample into the light path
d) photosensor for determining the total light intensity after passing through the sample.

2. A method according to claim 1, wherein the optical modulator is between the light source and the sample holder.

3. A method according to claim 1, wherein the sample holder is between the light source and the optical modulator.

4. A method according to claim 2, wherein a lens or focusing mirror is between the light source and the optical modulator.

5. A method according to claim 2, wherein a lens or focusing mirror is between the optical modulator and sample photosensor.

6. A method according to claim 3, wherein a lens or focusing mirror is between the light source and sample holder.

7. A method according to claim 3, wherein a lens or focusing mirror is between the sample holder sample photosensor.

8. A method according to claim 1, wherein the photosensor is a silicon photodiode.

9. A method according to claim 1, wherein the optical spectral measurement absorbance range is wavelengths between 180 nm and 1050 nm.

10. A method for detecting and measuring spectral absorbance of a sample comprising:
a) a light source able to produce light in the desired wavelength region to be measured for spectral absorbance.
b) optical modulator capable of temporally changing the spectral wavelength proportion of the light source.
c) sample holder capable of introducing the sample into the light path
d) photosensor for determining the total light intensity after passing through the sample.
e) a beam splitter for splitting a portion of the light prior to passing through the sample cell to a reference photosensor.

11. A method according to claim 10, wherein the optical modulator is between the light source and the sample holder.

12. A method according to claim 10, wherein the sample holder is between the light source and the optical modulator.

13. A method according to claim 11, wherein a lens or focusing mirror is between the light source and the optical modulator.

14. A method according to claim 11, wherein a lens or focusing mirror is between the optical modulator and sample photosensor.

15. A method according to claim 12, wherein a lens or focusing mirror is between the light source and sample holder.

16. A method according to claim 12, wherein a lens or focusing mirror is between the sample holder sample photosensor.

17. A method according to claim 10, wherein the photosensor is a silicon photodiode.

18. A method according to claim 10, wherein the optical spectral measurement absorbance range are wavelengths between 180 nm and 1050 nm.

19. An apparatus for determination of spectral absorbance comprising:
a) optical light source emitting in the desired spectral absorbance region
b) an optical modulator comprised of a circular or spherical optically transmissive element mounted such that a rotation of the element induces a change in the wavelength proportions of the transmitted light in the measurement spectrum area.
c) sample holder capable of introducing the sample into the light path
d) photosensor for determining the total light intensity after passing through the sample.

20. An apparatus for determination of spectral absorbance comprising:
a) optical light source emitting in the desired spectral absorbance region
b) an optical modulator comprised of a circular or spherical optically transmissive element mounted such that a rotation of the element induces a change in the wavelength proportions of the transmitted light in the measurement spectrum area
c) sample holder capable of introducing the sample into the light path
d) photosensor for determining the total light intensity after passing through the sample.
e) a beam splitter for splitting a portion of the light prior to passing through the sample cell to a reference photosensor.

21. A method where claims 1-20 use an analog to digital converter to obtain the output of the photosensor(s).
